(19) United States
(12) Patent Application Publication
(10) Pub. No.: US 2006/0097968 A1
(43) Pub. Date: May 11, 2006

(54) Display apparatus

(76) Inventors: Tsunenori Yamamoto, Hitachi (JP); Akitoyo Konno, Hitachi (JP); Tatsuki Inuzuka, Hitachi (JP); Yasutaka Toyoda, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/249,592

(22) Filed: Oct. 14, 2005

(30) Foreign Application Priority Data
Oct. 15, 2004 (JP) 2004-300901

(51) Int. Cl. G09G 3/36

(52) U.S. Cl. 345/87

(57) ABSTRACT

A display apparatus includes an illuminator for irradiating light onto the light bulb, and a control unit that includes a data analyzer for analyzing image data, an image memory for storing the image data, a display-data generating converter for converting the stored image data to display-data for the light bulb, and an illumination adjuster for adjusting the amount of light emission from the illuminator, in which the illuminator is divided into n controllable regions in the direction and the inputted image data is sequentially displayed on the light bulb, and the amounts of data conversion and light emission in the control unit are determined repeatedly n times within each frame period, and applied to each region of the illuminator and to each region of the light bulb opposite to the illuminator.

### BACKGROUND OF THE INVENTION

The present invention relates to a display apparatus capable of displaying with good quality.

Recently, various liquid display apparatus have been developed for displaying better-quality images. There is an example disclosed in Japanese Patent No. 3215400, in which a technique is used to expand the dynamic range by dynamically controlling the contrast and the brightness of the backlight according to the image data inputted to be displayed. Another example is proposed as described in JP-A-2002-333858, in which the image data similarly inputted to be displayed is analyzed and used to control the gradation-brightness characteristic (hereinafter, referred to as the gamma characteristic) so that the image can be dynamically displayed.

In addition, the conventional liquid display apparatus has a relatively slow response time of 10 to 30 ms that is taken for the display to change from black to white or white to black when the liquid display apparatus responds to the voltage change. Moreover, the response time taken for the display to change from white to the intermediate gradation or from black to the intermediate gradation is as slower as 20 to 50 ms. When a moving picture containing much intermediate gradation such as TV image is displayed, an afterimage phenomenon occurs as the image leaves the tail.

All these liquid display apparatus employ the display system called the “hold type” in which the same image is continuously supplied during one period, or frame of the video signal.

When a moving picture such as TV is displayed on this hold-type liquid display apparatus, the image that is to sequentially move is displayed at the same position during one frame. In other words, the image is displayed in the correct position at a certain instant within one frame, but at another instant, the image is displayed in a position different from that in which it should be actually displayed. The human views the moving picture by averaging the movement, and thus feels that the image is blurred.

The response-speed problem of these problems is solved by the technique proposed by H. Okumura et al., SID 92 DIGEST, p 601 (1992). In this technique, the image data from a video signal source is compared with that located one frame before. If a change is found from the comparison, the image data is converted so that the change can be magnified. Then, the associated pixels can be changed to the values corresponding to the initial image data by the time the next frame comes. By this technique, it is possible to make the speed of the response to the intermediate gradation substantially equal to that to the white or black, and thus to eliminate the afterimage that appears when a moving picture is displayed.

Moreover, the document IDRC 97, p203 (1997) written by Sueoka et al. describes a technique as the countermeasure against the blur of moving picture due to the hold-type light emission. In this technique, the whole liquid crystal panel is scanned to make the liquid crystal responsive and then the backlight is turned on so that the blur of image due to the averaging mentioned previously can be eliminated. In addition, JP-A-2000-275604 is proposed in which the backlight region is divided into a certain number of regions, and each backlight region is turned on in synchronism with the scanning for the displaying of image on the liquid crystal panel.

In order to improve the quality of TV receivers using those liquid crystal apparatus, or the so-called liquid crystal TV, however, it is necessary to analyze the inputted image and control the backlight as in Japanese Patent No. 3215400. In addition, as in JP-A-2002-333858, in order to control the gamma characteristic of the liquid, the following processes are required. It is necessary to analyze all the image data of one frame inputted during the first frame period, and to determine the amount of control of backlight and the amount of change of the gamma characteristic. Then, the image data inputted during the first frame period is required to display in the second frame period while the gamma characteristic conversion and backlight control are being performed.

When the image data is inputted and converted during the first frame period and is supplied to the display apparatus in the second frame period, there is the problem that the inputted image data is displayed late. If, for example, the user pushes a button with a delay of one frame, or about 16.6 ms as in a TV game in which the timing of pushing buttons in response to the change of image is severe (such as pushing a button on a game machine the instant that the displayed image changes), there is a possibility that an abnormal operation occurs.

On the other hand, when the image data inputted during the first frame period is converted according to the result of analyzing the image data of the previous frame, the delay of image on the display can be eliminated, but the quality of the displayed image is deteriorated.

### SUMMARY OF THE INVENTION

It is an object of the invention to solve these problems. In other words, the object of the invention is to provide a high-quality liquid crystal display apparatus in which the inputted images are analyzed and used to control the backlight and gamma characteristic so that the delay of image on the display can be eliminated and that the picture quality can be prevented from being deteriorated.

According to this invention, there is provided a liquid crystal display apparatus having a liquid crystal display with a liquid crystal layer held between a pair of substrates, an image memory for storing image data to the liquid crystal display, a data analyzer for analyzing the image data so that every 1/n (n is an integer of 2 or greater) part of each frame of the image data to the liquid crystal display can be processed at a time and for supplying the analyzed result, a display-data generating converter for generating display-data and supplying it to the liquid crystal display on the basis of the image data stored in the image memory and the analyzed result, and a gradation-setting voltage generator for controllably generating a gradation-setting voltage to the liquid crystal display on the basis of the analyzed result.

In addition, there is another liquid crystal display apparatus having a liquid crystal display with a liquid crystal layer held between a pair of substrates, an image memory for storing image data to the liquid crystal display, a data analyzer for analyzing the image data so that every 1/n (n is an integer of 2 or greater) part of each frame of the image data to the liquid crystal display can be processed at a time and for supplying the analyzed result, a display-data generating converter for generating display-data and supplying it to the liquid crystal display on the basis of the image data stored in the image memory and the analyzed result, an illumination adjuster capable of adjusting the amount of light emission from an illuminator on the basis of the analyzed result, and the illuminator capable of changing the amount of light emission for each of n number of divided regions.

In this case, the illuminator takes a structure formed of n regions into which the illuminator is divided in the direction in which the inputted image data is sequentially displayed on the liquid crystal display.

In addition, there is another liquid crystal display apparatus having a liquid crystal display with a light bulb, an image memory for storing image data to the liquid crystal display, a data analyzer for analyzing the image data so that every 1/n (n is an integer of 2 or greater) of each frame of the image data to the liquid crystal display can be processed at a time and for supplying the analyzed result, a display-data generating converter for generating display-data and supplying it to the liquid crystal display on the basis of the image data stored in the image memory and the analyzed result, an illumination adjuster capable of adjusting the amount of light emission from an illuminator on the basis of the analyzed result, and a polygon mirror that is rotated to control the light from a light source.

In this case, the polygon mirror may take a structure capable of allocating the light from the light source to the n regions.

Moreover, the display-data generating converter and the gradation-setting voltage generator are constructed to respectively convert an amount of data and generate a gradation-setting voltage repeatedly n (n is an integer of 2 or greater) times within one-frame period.

In addition, the display-data generating converter and the illumination adjuster are constructed to respectively convert an amount of data and adjust an amount of light emission repeatedly n (n is an integer of 2 or greater) times within one-frame period.

In addition, there is provided a display apparatus having a light bulb formed of a plurality of pixels and capable of controlling each pixel to permit light to be reflected from itself and penetrated through itself, an illuminator for irradiating light onto the light bulb and capable of controlling the amount of its light emission, and a control unit including a data analyzer for analyzing image data inputted so as to be displayed on the light bulb, an image memory for storing the image data until the analysis is completed, a display-data generating converter for converting the stored image data to generate display-data to the light bulb on the basis of the analyzed result, and an illumination adjuster for adjusting the amount of light emission on the basis of the analyzed result, wherein the illuminator is divided into n individually controllable regions in the direction in which the inputted image data is sequentially displayed on the light bulb, and the amounts of data conversion and light emission in the control unit are determined repeatedly n times within one-frame period and applied to each region of the illuminator and to each region of the light bulb opposite to the illuminator.

Furthermore, there is another display apparatus having a liquid crystal display formed of a plurality of pixels and for controlling each pixel to permit light to be reflected from itself and penetrated through itself, an illuminator for irradiating light onto the liquid crystal display and capable of controlling the amount of light emission, a gradation-setting voltage generator for controllably generating a gradation-setting voltage to the liquid crystal display, and a control unit including a data analyzer for analyzing image data inputted so as to be displayed on the liquid crystal display, an image memory for storing the image data until the analysis is completed, a display-data generating converter for converting the stored image data to generate display-data to the liquid crystal display on the basis of the analyzed result, and an illumination adjuster for adjusting the amount of light emission from the illuminator on the basis of the analyzed result, wherein the illuminator is divided into n individually controllable regions in the direction in which the liquid crystal display is vertically scanned, the amounts of data conversion and light emission in the control unit and the gradation-setting voltage are determined repeatedly n times within one-frame period and applied to each region of the illuminator and to each region of the liquid crystal display opposite to the illuminator, and the gradation-setting voltage from the gradation-setting voltage generator is changed n times within one-frame period.

In this case, when the amounts of data conversion and light emission are determined repeatedly n times within one-frame period, the amount of light emission based on the data analysis of the (m+1)-th region is reflected on the conversion of the m-th region of the n regions of image data to the display-data.

In addition, in the above construction, the capacity of the image memory is 2/n the amount of one-frame data.

Also, in the above construction, the n takes any integer between 8 and 16 both inclusive.

According to the invention, a high-quality liquid crystal display apparatus can be provided with the picture quality not deteriorated and with the delay of image on the display being eliminated.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of the display apparatus of embodiment 1.

FIG. 2 is a timing chart showing the flow of processes for display-data and sequences of data in embodiment 1.

FIG. 3 is a block diagram of the display apparatus of embodiment 2.

FIG. 4 is a timing chart showing the flow of processes for display-data and sequences of data in embodiment 2.

FIG. 5 is a block diagram of the display apparatus of embodiment 3.

FIG. 6 is a timing chart showing the flow of processes for display-data and sequences of data in embodiment 3.

FIG. 7 is a timing chart showing the flow of processes for display-data and sequences of data in embodiment 4.

FIG. 8 is a block diagram of the display apparatus of embodiment 5.

### DETAILED DESCRIPTION OF THE EMBODIMENTS

### Embodiment 1

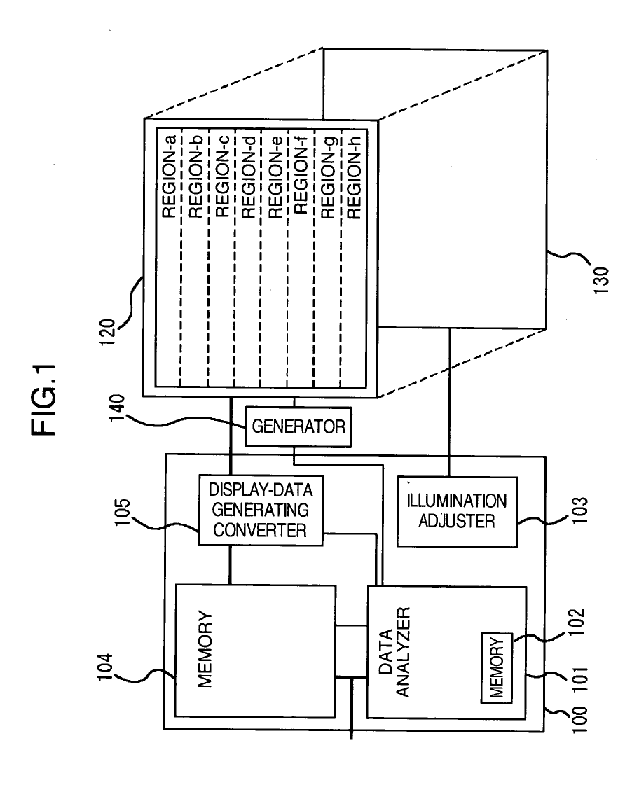

FIG. 1 is a block diagram of this embodiment 1.

The display apparatus of this embodiment has a control unit 100 that includes a data analyzer 101, an illumination adjuster 103, an image memory 104 and a display-data generating converter 105, a liquid crystal display 120, an illuminator 130 and a gradation-setting voltage generator 140. The displaying area of the liquid crystal display 120 is imaginarily divided into 8 regions (region-a through region-h) in the vertical synch direction in which the image signal data is sequentially inputted. In addition, the data analyzer 101 includes an analyzer's internal memory 102 for use in analyzing the image data.

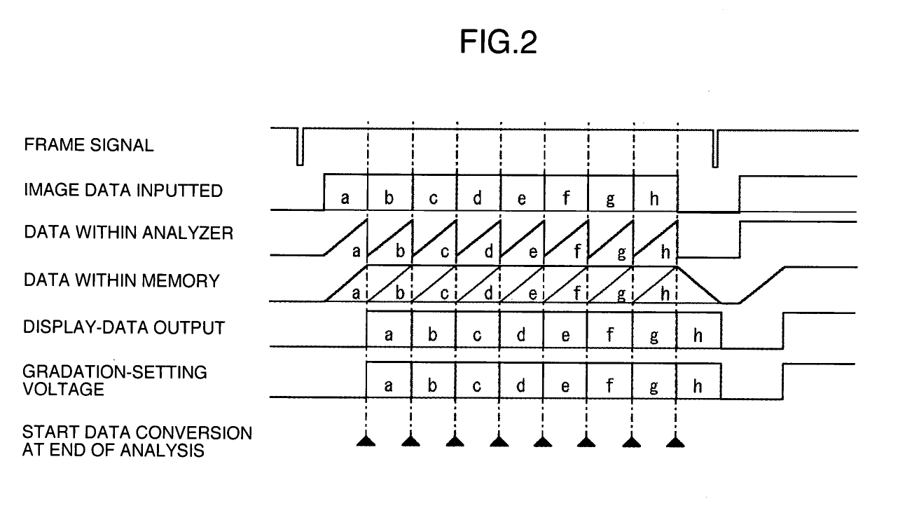

The flow of processes for image data and the sequences of data processed in order for the image data to be displayed in this embodiment will be described with reference to FIGS. 1 and 2.

The image data produced from an image processor incorporated in a personal computer, TV tuner or TV receiver is first supplied to the control unit 100. The image signal thus fed is sequentially stored in the image memory 104, and at the same time fed to the data analyzer 101 where it is sampled for each 2×2 pixels at a time and analyzed for histogram. This histogram analysis is performed in the analyzer's internal memory 102.

When the first ⅛ frame (for region-a) of image data is completely inputted, the histogram analysis is once stopped, and the optimum gradation-setting voltage and amount of conversion to display-data are determined by using the histogram data obtained so far. The gradation-setting voltage and amount of conversion to display-data is used for the region (region-a) of the liquid display 120 to display the first inputted image data.

The display-data is started to convert to and supply to the region-a of the liquid crystal display 120 immediately after the amount of conversion is determined. While the image data for the region-a that is stored within the image memory 104 is being converted to the display-data by the display-data generating converter 105, it is supplied to the liquid crystal display 120. At the same time, the gradation-setting voltage generator 140 generates the gradation-setting voltage for region-a, and supplies it to the liquid crystal display 120.

On the other hand, the image data is continuously supplied, or the image data for the next region-b is supplied to the control unit. This image data is also sequentially stored in the image memory 104 and analyzed for histogram by the data analyzer 101 as is the data for region-a. However, since the previous histogram data is erased just after the amount of conversion to display-data is determined, only the image data for region-b is analyzed for histogram. In addition, since the region-a image data read out is equal to the region-b image data written in the memory, it is enough for the memory 104 to have a capacity corresponding to ⅛ frame. However, if the input/output bus width and data speed are not sufficient, twice that amount may be sometimes used.

While the image data for region-b is fed just after the image data for region-a as described above, the image data is actually partitioned into lines, or supplied line by line, and thus the image data is intermittently supplied. In this intermittent period, the gradation-setting voltage and amount of light emission from the illuminator are determined by using the result of histogram analysis.

When the image data for region-b is finished in its supply, the histogram analysis is once stopped, and the gradation-setting voltage and amount of conversion to display-data are determined as mentioned about the process for the region-a. Then, while the image data for region-b is being converted to display-data, it is started to supply to the region-b. At the same time, the gradation-setting voltage for the region-b is controlled to generate by the gradation-setting voltage generator 140, as is the voltage for the region-a, and supplied to the liquid crystal display 120.

As described above, this embodiment imaginarily divides the liquid crystal display 120 into 8 regions in the vertical sync direction in which the image signal data is sequentially fed, and repeats 8 times the analysis of the inputted image data and the determination of the gradation-setting voltage and amount of conversion to display-data during one-frame period. Thus, the gradation-setting voltage from the gradation-setting voltage generator is changed 8 times within each frame in order to apply to the eight imaginary regions.

Thus, since the period of time between the inputting of image data and the outputting of display-data is reduced to ⅛ of one frame with the picture quality not deteriorated, the image delay time can be much decreased.

In addition, since the image data is divided into 8 parts, or regions and analyzed for each region to be converted for high quality, the image data can be more minutely analyzed and more precisely controlled for each region than in the case where image data of one full frame is converted at a time. Thus, the image data can be displayed with high quality.

Moreover, according to the invention, the amount of storage necessary for the analyzer's inner memory 102 can be reduced, thus leading to low cost.

The reduction of the memory capacity can be said to produce the following merits.

According to this embodiment as described above, when the inputted image data is analyzed in the first frame period to produce as the analyzed result in the second frame period, it is necessary that a memory region depending on the kind and frequency of data analysis be provided as a data-analyzing region for analyzing the image data of one frame. If, for example, the gradation histogram within one frame is analyzed by sampling each four pixels at a time, the counter for recording the number of appearance of each gradation needs to be able to count up to the number of pixels divided by four. If the number of pixels is 1024×768, the counter needs to count up to 196,608, or an 18-bit counter is necessary. In addition, since the necessary number of those counters corresponds to the gradation number (for example, 256), 4608 flip-flop circuits must be provided. In this case, this embodiment repeats, 8 times within one frame period, the operations to analyze the inputted data and to determine the gradation-setting voltage and amount of conversion to display-data by using the analyzed result. Therefore, the necessary capacity of the analyzer's inner memory 102 for use in the histogram analysis can be reduced to ⅛ that in the case where those processes for the analysis are only once made within one frame period.

While the data analyzer 101 and analyzer's inner memory 102 are respectively formed by hardware circuits and counters in this embodiment, the data analyzer 101 and the histogram analysis can be respectively implemented by using a micro-controller and software. Even in this case, the capacity of analyzer's inner memory 102 necessary for the histogram analysis can be apparently reduced to about ⅛ as much.

How to determine the gradation-setting voltage and amount of conversion to display-data by using the result of histogram analysis is described in JP-A-2002-333858.

While only the histogram analysis is used to analyze the image data in this embodiment, the caption in a movie on the display can be detected by analyzing the data of the appearance frequency of particular gradations projected in the vertical and horizontal directions of the image data. The region in which the caption is displayed on the liquid crystal display 120 can be provided and controlled separately from the region in which the image is displayed. In addition, this embodiment made the above analysis of image data and determination of the amount of data conversion and gradation-setting voltage for each color of R, G and B. However, when the gradation-setting voltage generator 140 cannot independently control each color of R, G and B, the analysis of image data and determination of the amount of data conversion and gradation-setting voltage may be made considering only the brightness.

In addition, in this embodiment, the illuminator 130 is not adjusted in its light emission according to the image data, but manually adjusted only in the brightness setting.

### Embodiment 2

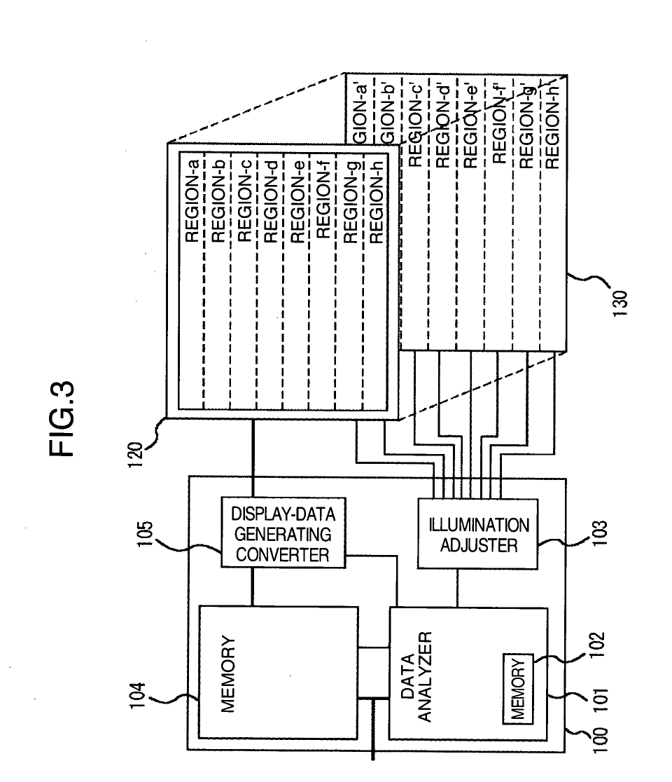

FIG. 3 is a block diagram of the display apparatus of this embodiment.

In this embodiment, no gradation-setting voltage generator is provided unlike the embodiment 1 having it connected to the data analyzer. However, the illuminator 130 is divided into 8 regions (region-a′ through region-h′) opposite to the eight regions (region-a through region-h) of the liquid crystal display 120 that are provided in the vertical synch direction in which the image data is sequentially inputted. The illumination controller 103 can independently control those regions.

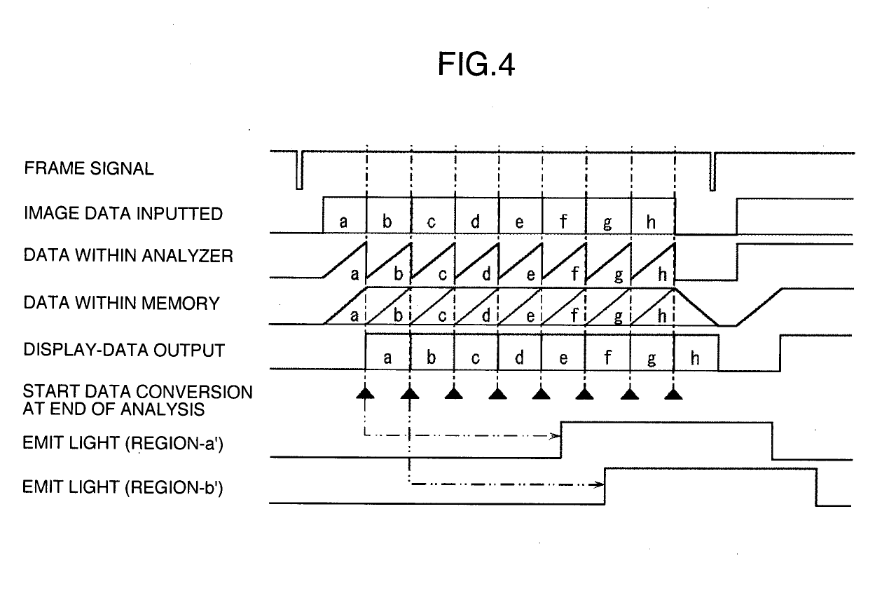

The flow of processes for image data and sequences of data processed in order for the image data to be displayed in this embodiment will be described with reference to FIGS. 3 and 4.

The flow of processes for inputting image data and making histogram analysis is the same as in the embodiment 1, but this embodiment is different from the embodiment 1 in that the histogram data obtained is used to determine the optimum amounts of illuminator emission and display data conversion.

The first amount of conversion to display-data is used for the region (region-a) in which the first inputted image data is displayed on the liquid crystal display 120. The amount of illuminator's light emission is used for the region (region-a′) of the eight regions of the illuminator 130 opposite to the region-a of the liquid crystal display 120. The conversion to display-data and the supply of display-data to the region-a of the liquid crystal display 120 are started just after the determination of the amount of conversion. That is, while the region-a image data stored in the image memory 104 is being converted to the display-data by the data converter 105, the produced display-data is supplied to the liquid crystal display 120. The region-a′ of the illuminator 130 is controlled in its light emission by the illumination adjuster 103. When the liquid crystal of the region-a of the liquid crystal display 120 becomes responsive enough, it is started to emit light.

When the image data for the region-b is completely inputted, the histogram analysis is once stopped as for the region-a, and the amount of illuminator's light emission and the amount of conversion to display-data are determined. While the image data is being converted, the display-data is started to supply to the region-b. The region-b′ of illuminator 130 is controlled in its light emission by the illumination adjuster 103 as is the region-a′. When the liquid crystal of the region-b of liquid crystal display 120 becomes responsive enough, or about ⅛ frame period after the light emission from the region-a′, the region-b′ is started to emit light.

Thus, in this embodiment, the illuminator is divided into 8 individually controllable regions in the vertical synch direction in which the image data is sequentially inputted. The inputted image data and the amounts of illuminator's light emission and conversion to display-data are, repeatedly 8 times within one frame period, analyzed and determined on the basis of the data analysis, respectively. The results of the repetitive analysis of image data and the repetitive determinations of those amounts are applied to the respective eight regions of the illuminator.

Thus, high-quality displaying of the image data can be made without deterioration of image. Since the period from when the inputted image data is converted to display-data to when the display-data is supplied to the display is reduced to ⅛ frame period, the image delay time can be suppressed to a very short time. Particularly in this embodiment, the backlight is divided into individually controllable regions, and thus sophisticated analysis is required. Thus, this effect makes the above features more predominant.

In addition, according to this embodiment, since the image data is divided into 8 parts, analyzed for each region and converted for high-quality data, the data can be more precisely analyzed and more minutely controlled for each region than when the image data of one frame is converted at a time. Thus, the image data can be displayed with high quality.

Moreover, according to this invention, the necessary amount of storage in the analyzer's inner memory 102 can be reduced, thus leading to low cost as described in the section of embodiment 1.

The amounts of illuminator's light emission and conversion to display-data are determined by using the result of histogram analysis as above. Those amounts can be computed by finding the maximum and minimum values, and average value of data as described in Japanese Patent No. 3215400. For simpler computation, only the maximum value of image data is considered, and the image data is converted to display-data so that the maximum value corresponds to the maximum gradation. On the other hand, the amount of illuminator's light emission is determined to decrease down to the gradation corresponding to the maximum value of data. However, in this simpler method, the amount of illuminator's light emission significantly increases and decreases due to noise, and the conversion to the display-data is sometimes not the optimum. Thus, the amounts of data conversion and illuminator's light emission are compensated for by classifying the image to be displayed according to the histogram. When the amounts of data conversion and illuminator's light emission are determined, it is possible to refer to the amount of light emission from the illuminator of the same region one frame before and to the environment of external light detected by an external light sensor.

In addition, while only the histogram analysis is used for the image data in this embodiment, the caption in a movie displayed can be detected by analyzing the image data that has the frequency of appearance of particular gradations projected in the vertical and horizontal directions of the display surface. The regions for the caption can be provided in the liquid crystal display 120 and illuminator 130 and controlled separately from the region in which the image is displayed.

In this embodiment, all the data format of image data to the display apparatus, the sub-pixel structure of liquid crystal display 120 and the light source of illuminator 130 are provided for each of the primary colors of red (R), green (G) and blue (B). There, the analysis of image data and the determination of the amounts of data conversion and illuminator's light emission are performed for each color of R, G and B. However, if the illuminator 130 cannot be controlled for each color of R, G and B, the analysis of image data and the determination of the amounts of data conversion and illuminator's light emission may be made considering only the brightness.

While the illuminator is divided into 8 regions in this embodiment, the number of regions may be 16 or 32. If the data analysis and the determination of the amounts of data conversion and illuminator's light emission are made repeatedly the same number of times within one frame period as that of regions, the necessary capacity of the memory within the analyzer can be further reduced. (That is, if the illuminator is divided into 16 or 32 regions, the capacity can be reduced to 1/16 or 1/32 frame.) In addition, since the image data can be more precisely analyzed and minutely controlled for each region, the image data can be displayed with higher quality, and the time from when the image data is inputted to when the display-data is supplied to the display can be further shortened. However, increasing the number of regions will increase the number of processes for controlling the regions of the illuminator, thus increasing the number of components such as switches with the result that the cost is slightly increased. In view of the current cost of parts and the desire for high quality, the number of regions, or divisions is preferably about 8 to 16 both inclusive. Thus, this embodiment employed eight regions.

In this embodiment, the current to the power supply for the illumination can be more dispersed on a time basis by shifting the timing of emitting light from each region of the illuminator 130 than in the case where the whole illuminator emits light at the same time. Thus, the capacity of the power supply can be reduced.

### Embodiment 3

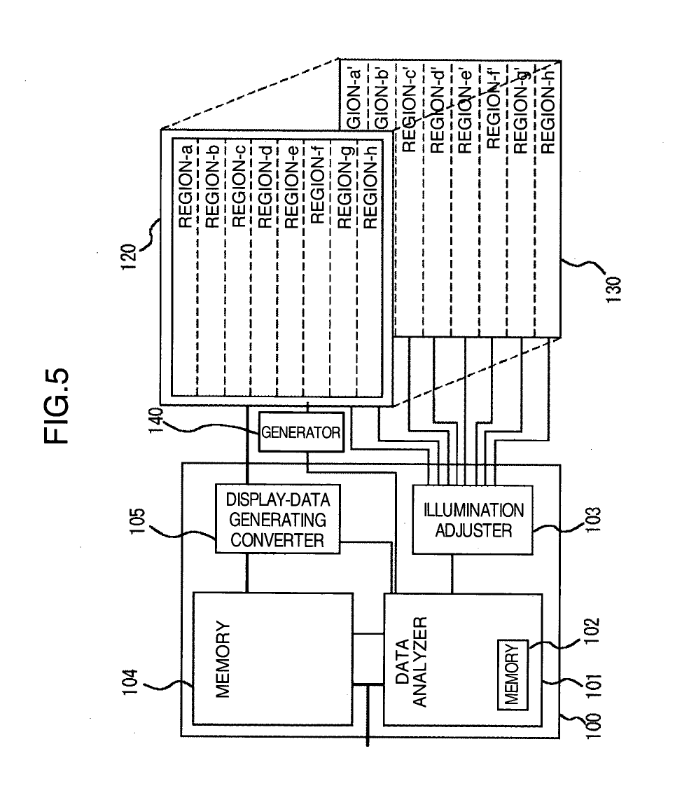

FIG. 5 is a block diagram of the display apparatus of this embodiment 3.

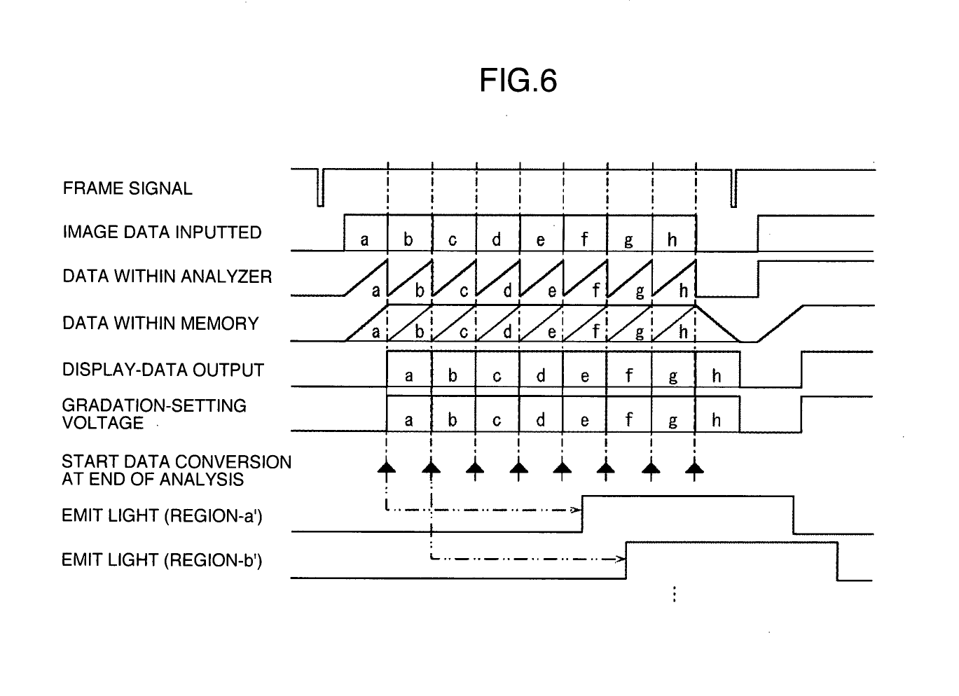

This embodiment is different from the embodiment 2 in that the gradation-setting voltage generator 140 is added to the construction of embodiment 2. The flow of processes for image data and sequences of data to be displayed in this embodiment will be described with reference to FIGS. 5 and 6.

Although the processes for inputting image data and making the histogram analysis are the same as in the embodiments 1 and 2, this embodiment employs the obtained histogram data to determine the optimum amounts of illuminator's light emission and data conversion and the optimum gradation-setting voltage differently from the previous embodiments.

When image data of ⅛ frame (for region-a) is completely inputted, the histogram analysis is once stopped, and the histogram data obtained so far is used to determine the optimum amounts of illuminator's light emission and data conversion and the optimum gradation-setting voltage. The amount of conversion to display-data and gradation-setting voltage determined here are used for the region (region-a) of liquid crystal display 120 in which the first inputted image data is displayed. The amount of illuminator's light emission is used for the region (region-a′) of the eight regions of the illuminator 130 that faces the region-a of the liquid crystal display 120.

The conversion to the display-data and supply it to the region-a of liquid crystal display 120 are started immediately after the amount of conversion is determined. While the image data for region-a stored within the image memory 104 is being converted to the display-data by the display-data generating converter 105, it is supplied to the liquid crystal display 120. At the same time, the gradation-setting voltage generator 140 generates the gradation-setting voltage for region-a and supplies it to the liquid crystal display 120. The region-a′ of illuminator 130 is controlled in its light emission by the illumination adjuster 103 so that it can start the light emission when the liquid of the region-a of liquid crystal display 120 becomes responsive enough. When the image data for region-b is completely inputted, the histogram analysis is once stopped as for the region-a. Then, processes are performed to determine the amounts of illuminator's light emission and data conversion and the gradation-setting voltage, and display-data is started to supply to the region-b while the image data is being converted to the display-data. At the same time, the gradation-setting voltage to the region-b is controlled to supply to the liquid crystal display 120 by the gradation-setting voltage generator 140 as supplied to the region-a. The region-b′ of illuminator 130, as is the region-a′, is controlled in its light emission by the illumination adjuster 103 so that it can start the light emission when the liquid of the region-b of liquid crystal display 120 becomes responsive enough, or about ⅛ frame after the light emission from region-a′.

Thus, in this embodiment, the illuminator is divided into 8 individually controllable regions in the vertical synch direction in which the image data is sequentially inputted. The inputted image data and the amounts of illuminator's light emission and conversion to display-data are respectively analyzed and determined based on the analyzed result repeatedly eight times within one frame period. The results of the data analysis and determinations of those amounts as repeated above are applied to the respective eight regions of each of the illuminator 130 and liquid crystal display 120.

Thus, high-quality image data can be displayed without deterioration of image. Since the time from when the image data is inputted to when it is displayed as display-data is shortened to ⅛ frame, the image delay time can be suppressed to a very short time.

In addition, according to this embodiment, since the image data is divided into eight portions and analyzed for each portion so that the data can be converted to high-quality data, the data can be more precisely analyzed and controlled more minutely for each portion than when the image data of one frame is converted at a time. Thus, the image data can be displayed with high quality.

In addition, the necessary storage capacity of the analyzer's inner memory 102 used for histogram analysis can be reduced to ⅛ that necessary for one frame to be analyzed at a time. While the data analyzer 101 is also formed of hardware circuits in this embodiment, it may be of course achieved by software using a micro-controller.

In this embodiment, since the amount of process for data analysis also increases, the above effect is more remarkable.

In addition, the method for data analysis may use not only histogram but also projection data. Also, in the case of determining the amounts of illuminator's light emission and data conversion and the gradation-setting voltage, it is possible to refer to the amount of illuminator's light emission of the same region one frame before and to the environment of external light detected by an external light sensor.

In this embodiment, all the data format of image data to the display apparatus, the sub-pixel structure of liquid crystal display 120, the light source of illuminator 130 and the gradation-setting voltage are provided for each of the primary colors of red (R), green (G) and blue (B). There, the analysis of image data and the determination of the amounts of data conversion and illuminator's light emission are performed for each color of R, G and B. However, if the illuminator 130 and gradation-setting voltage generator cannot be controlled for each color of R, G and B, the analysis of image data and the determination of the amounts of data conversion and illuminator's light emission and the gradation-setting voltage may be made considering only the brightness.

In this embodiment as described above, the illuminator 130 is divided into eight regions in the direction in which data is inputted, and the amounts of data conversion and light emission and the gradation-setting voltage are determined repeatedly eight times within one frame period by using the result of data analysis. Therefore, the capacity of the memory used for the data analysis within the analyzer can be reduced to ⅛ that for one-frame data, thus leading to low cost. Moreover, a high-quality display can be provided by adjusting the gradation-setting voltage for each region.

Moreover, as in the embodiment 1 since the data to be actually displayed is stored and analyzed at the same time, and since the stored data is converted according to the result of the analysis and displayed as display-data, the image data can be eventually displayed with high quality. In addition, since the period from when the image data is inputted to when it is supplied as display-data can be reduced to ⅛ frame period, the image delay time can be much shortened.

### Embodiment 4

This embodiment 4 is the same as embodiment 2 except for the following features.

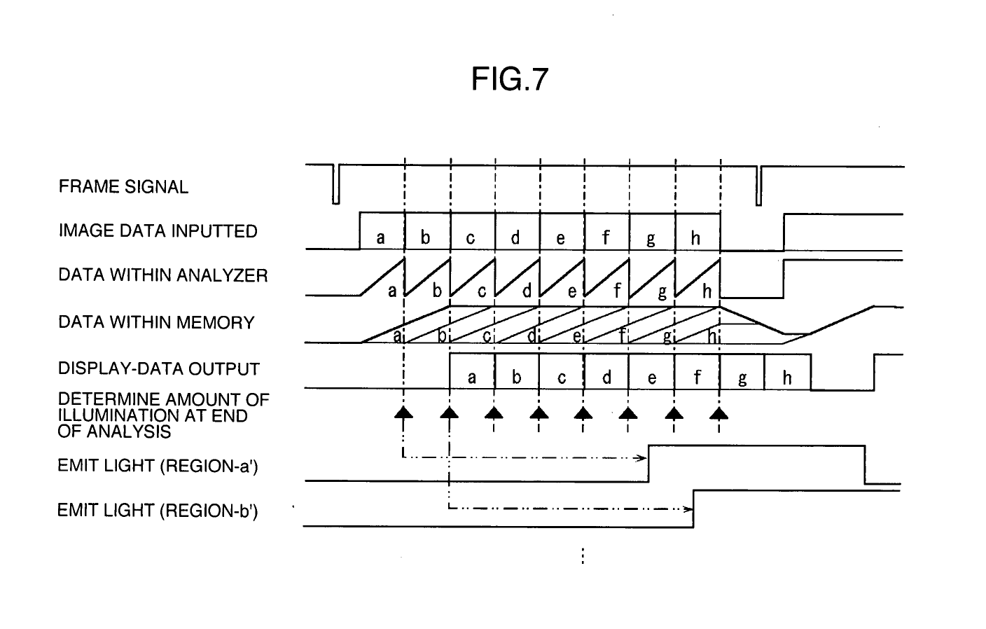

The flow of processes for image data and sequences of data to be displayed in this embodiment will be described with reference to FIG. 7.

In this embodiment, the image data fed from an image processor or the like is supplied to the control unit 100 where it is analyzed for histogram. When the image data of ⅛ frame (corresponding to region-a) is completely fed, the histogram analysis is once stopped. Then, the optimum amounts of illuminator's light emission and data conversion are determined by using the histogram data obtained so far. These processes are the same as in the embodiment 2.

In this embodiment, however, data conversion and supply of display-data to the region-a of liquid crystal display 120 are not made immediately after the determination of the amount of conversion. Those processes are made after the completion of data analysis for the next region-b, the determination of the amount of illuminator's light emission and then the correction for amount of data conversion to region-a. This is because the correction for amount of conversion of data to region-a is made considering that the light from each region of illuminator 130 extends to the other regions, or considering the effect of the amount of light to region-b on the region-a. In addition, the amount of conversion of data to region-b is corrected considering the amount of light to region-a (determined when data analysis for region-b is finished) and the amount of light to region-c (determined when data analysis for region-c is finished, or after the next ⅛ frame). Thus, data is started to convert and supply as display-data to the region-b of liquid crystal display 120 after the data analysis for region-c is finished that follows ⅛ frame after the completion of data analysis for region-b.

In this case, a time of 2/8 frame is elapsed until the display data is supplied after the inputting of the image data, and the amount of data to be stored in the image memory 104 corresponds to the amount of 2/8 frame. Therefore, in this embodiment, the capacity of the image memory 104 is 2/8 of one frame. This embodiment is the same as embodiment 1 in that, if the input/output bus width and speed are insufficient, the memory capacity is required to increase twice as much.

Although this embodiment has changes as above, the image delay time and the cost can be reduced as in the embodiment 2. In this embodiment, the period from when the image data is inputted to when the display-data is supplied to the display is 2/8 frame.

In addition, since data is converted to display-data considering the crosstalk of illumination light between regions, a display apparatus having higher picture quality can be provided than in the embodiment 2.

Since the display apparatus of this embodiment has the gradation-setting voltage generator 140 provided as in the embodiment 3, the gradation-setting voltage can naturally be changed for each region.

### Embodiment 5

This embodiment 5 is the same as embodiment 4 except for the following features.

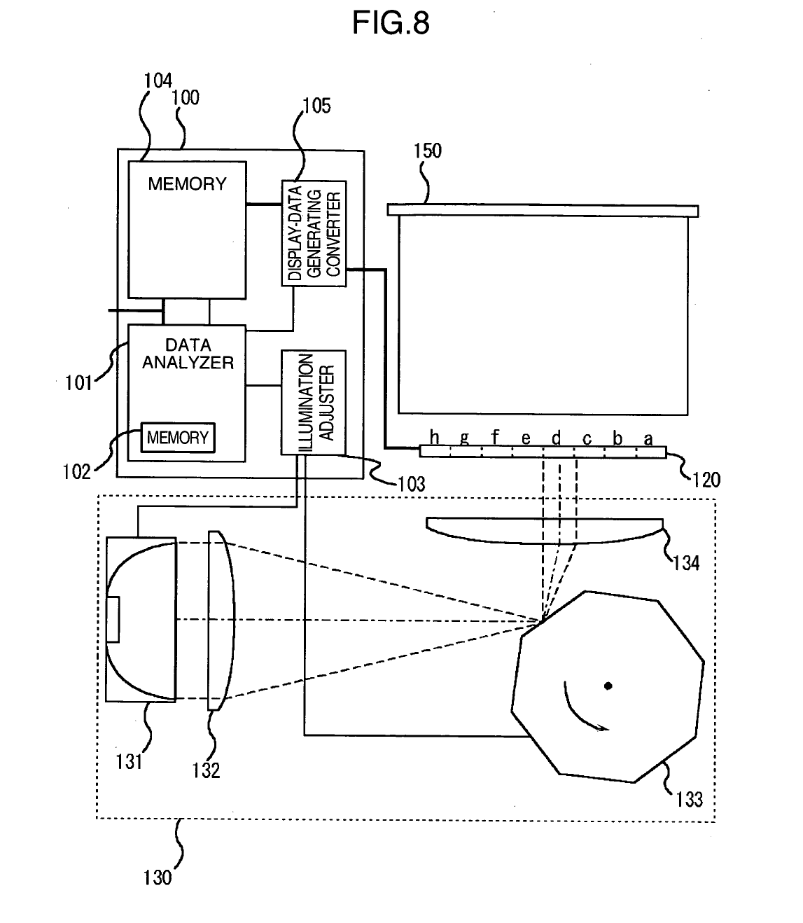

FIG. 8 is a block diagram of the display apparatus of this embodiment.

The display apparatus of this embodiment has the control unit 100 including the data analyzer 101, the illumination adjuster 103, the image memory 104 and the display-data generating converter 105, the liquid crystal display 120, and the illuminator 130 as does the embodiment 4. However, the illuminator 130 is not of a direct-view type in the embodiments 1 and 4, but a scroll-type illuminator that has a light source 131, a lens 132, a polygon mirror 133 and a lens 134. In addition, the display apparatus of this embodiment is not a direct-view display apparatus like the embodiment 4, but a projection-type display apparatus in which a projection optical system 150 is used to project the light from the illuminator 130 through the liquid crystal display 120 as a light bulb.

The light from the light source 131 is focused by the lens 132, and reflected from the polygon mirror 133 again into the lens 134 so that the light can be formed as parallel light and be irradiated onto the liquid crystal display 120. In this case, the region to be irradiated from the illuminator 130 at a certain time is equal to one of the 8 regions (region-a˜region-h) into which the display surface of the liquid crystal display 120 is divided in the vertical synch direction in which the image signal data is sequentially inputted. In addition, since the polygon mirror 133 is rotated in synchronism with the image-rewriting period of the liquid crystal display 120, the irradiated region is shifted from region to region in synchronism with the image-rewriting period of the liquid crystal display 120. The light source 131 is controlled 8 times in its amount of emission during one frame scanning period in synchronism with this shift of the irradiated region, thus making it possible to change the amount of light emission to each region of the liquid crystal display 120.

The data analysis and determination of the amounts of data conversion and illuminator's light emission for each region are the same as in embodiment 4, but the illumination adjuster 103 controls the amount of light emission from the light source 131 and the rotation of the polygon mirror 133 to adjust the amount of irradiation light to each region.

As described above, in this embodiment, the illuminator 130 scans the irradiation light in the vertical scanning direction in synchronism with the displaying of image on the surface of liquid crystal display 120. The determination process for the amounts of illuminator's light emission and data conversion by using the result of data analysis is repeated 8 times within one frame period. Along with this process, the amount of irradiated light is controlled 8 times during the one frame scanning period. The feature of this embodiment is that the polygon mirror 133 synchronizes the operations between the shift of irradiated region and the image-rewriting period.

Although the display apparatus of this embodiment is not the direct-view type display unlike the embodiment 4, but the projection-type display apparatus, the image delay time and cost can be reduced as in the embodiment 2.

This embodiment analyzes the image data and determines the amounts of data conversion and illuminator's light emission for each color of R, G and B. However, if the illuminator 130 cannot be controlled for each color of R, G and B, only the brightness can be considered for the analysis of image data and determination of the amounts of data conversion and illuminator's light emission.

In addition, in this embodiment, too, the addition of the gradation-setting voltage generator 140 as in the embodiment 3 is naturally effective to change the gradation-setting voltage for each region.

While the liquid crystal display 120 is used as a light-transmission type light bulb in this embodiment, the light-reflecting type liquid crystal may be used as a light bulb if the projection optical system 150 is partially changed in its structure. In addition, a micro-mirror device that controls the light bulb may be used if the light reflection angle is changed for each pixel.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display apparatus comprising:
a liquid crystal display having a liquid crystal layer held between a pair of substrates;
an image memory for storing image data of said liquid crystal display;
a data analyzer for analyzing said image data of said liquid crystal display so that every 1/n (n is an integer of 2 or greater) of each frame of said image data can be analyzed at a time, and for supplying said analyzed result;
a display-data generating converter for generating display-data on the basis of said image data stored in said image memory and said analyzed result, and for supplying said generated display-data to said liquid crystal display; and
a gradation-setting voltage generator for controllably generating a gradation-setting voltage to said liquid crystal display on the basis of said analyzed result.

2. A liquid crystal display apparatus comprising:
a liquid crystal display having a liquid crystal layer held between a pair of substrates;
an image memory for storing image data of said liquid crystal display;
a data analyzer for analyzing said image data of said liquid crystal display so that every 1/n (n is an integer of 2 or greater) of each frame of said image data can be analyzed at a time, and for supplying said analyzed result;
a display-data generating converter for generating display-data on the basis of said image data stored in said image memory and said analyzed result, and for supplying said generated display-data to said liquid crystal display;
an illumination adjuster capable of adjusting the amount of light emission from an illuminator on the basis of said analyzed result; and
said illuminator capable of changing the amount of light emission from each 1/n division of said illuminator.

3. A liquid crystal display apparatus according to claim 2, further comprising a gradation-setting voltage generator for controllably generating a gradation-setting voltage to said liquid crystal display on the basis of said analyzed result.

4. A liquid crystal display apparatus according to claim 2, wherein said illuminator is divided into n regions in the direction in which said imaged data inputted is sequentially displayed.

5. A liquid crystal display apparatus comprising:
a liquid crystal display having a liquid crystal layer held between a pair of substrates;
an image memory for storing image data of said liquid crystal display;
a data analyzer for analyzing said image data of said liquid crystal display so that every 1/n (n is an integer of 2 or greater) of each frame of said image data can be analyzed at a time, and for supplying said analyzed result;
a display-data generating converter for generating display-data on the basis of said image data stored in said image memory and said analyzed result, and for supplying said generated display-data to said liquid crystal display;
an illumination adjuster capable of adjusting the amount of light emission from an illuminator on the basis of said analyzed result; and
a polygon mirror that is rotated to control light from a light source.

6. A liquid crystal display apparatus according to claim 5, further comprising a gradation-setting voltage generator for controllably generating a gradation-setting voltage to said liquid crystal display on the basis of said analyzed result.

7. A liquid crystal display apparatus according to claim 5, wherein said polygon mirror controls light from said light source to be allocated to n regions.

8. A liquid crystal display apparatus comprising:
a liquid crystal display having a liquid crystal layer held between a pair of substrates;
an image memory for storing image data of said liquid crystal display;
a data analyzer for analyzing said image data of said liquid crystal display and for supplying said analyzed result;
a display-data generating converter for generating display-data on the basis of said image data stored in said image memory and said analyzed result, and for supplying said generated display-data to said liquid crystal display; and
a gradation-setting voltage generator for controllably generating a gradation-setting voltage to said liquid crystal display on the basis of said analyzed result,
said display-data generating converter and said gradation-setting voltage generator being respectively controlled to repeat the conversion of an amount of said image data and the generation of gradation-setting voltage n (n is an integer of 2 or greater) times within each frame.

9. A liquid crystal display apparatus comprising:
a liquid crystal display having a liquid crystal layer held between a pair of substrates;
an image memory for storing image data of said liquid crystal display;
a data analyzer for analyzing said image data of said liquid crystal display and supplying said analyzed result;
a display-data generating converter for generating display-data on the basis of said image data stored in said image memory and of said analyzed result, and for supplying it to said liquid crystal display;
an illumination adjuster capable of adjusting the amount of light emission from an illuminator on the basis of said analyzed result; and
said illuminator,
said display-data generating converter and said illumination adjuster being respectively controlled to repeat the conversion of an amount of said image data and the generation of an amount of light emission n (n is an integer of 2 or greater) times within each frame.

10. A liquid crystal display apparatus according to claim 9, wherein said illuminator is able to change the amount of light emission to each of n divisions.

11. A liquid crystal display apparatus comprising:
a liquid crystal display having a liquid crystal layer held between a pair of substrates;
an image memory for storing image data of said liquid crystal display;
a data analyzer for analyzing said image data of said liquid crystal display and supplying said analyzed result;
a display-data generating converter for generating display-data on the basis of said image data stored in said image memory and of said analyzed result, and for supplying it to said liquid crystal display;
an illumination adjuster capable of adjusting the amount of light emission from an illuminator on the basis of said analyzed result; and
a polygon mirror that is rotated to control light from a light source,
said display-data generating converter and said illumination adjuster being respectively controlled to repeat the conversion of an amount of said image data and the generation of an amount of light emission n (n is an integer of 2 or greater) times within each frame.

12. A liquid crystal display apparatus according to claim 11, wherein said polygon mirror controls light from said light source to be allocated to n regions.

13. A display apparatus comprising:
a light bulb that has a plurality of pixels and that controls each of said pixels to permit light to reflect from itself and penetrate through itself; and
an illuminator that irradiates light onto said light bulb and that can control the amount of its light emission; and
a control unit having a data analyzer for analyzing image data inputted so that it can be displayed on said light bulb, an image memory for storing said image data until it can be completely analyzed, a display-data generating converter for converting said stored image data on the basis of said analyzed result and supplying it as display-data to said light bulb, and an illumination adjuster for adjusting the amount of light emission from said illuminator on the basis of said analyzed result, wherein
said illuminator is divided into n individually controllable regions in the direction in which said inputted image data is sequentially displayed on said light bulb, and
the amounts of data conversion and light emission are determined in said control unit repeatedly n times within each frame period, and applied to each region of said illuminator and to each region of said light bulb opposite to said illuminator.

14. A display apparatus comprising:
a liquid crystal display that has a plurality of pixels and that controls each of said pixels to permit light to reflect from itself and penetrate through itself;
an illuminator that can irradiate light onto said liquid crystal display and control the amount of its light emission;
a gradation-setting voltage generator for controllably generating a gradation-setting voltage to said liquid crystal display; and
a control unit having a data analyzer for analyzing image data inputted so that it can be displayed on said display, an image memory for storing said image data until it can be completely analyzed, a display-data generating converter for converting said stored image data on the basis of said analyzed result and supplying it as display-data to said liquid crystal display, and an illumination adjuster for adjusting the amount of light emission from said illuminator on the basis of said analyzed result, wherein
said illuminator is divided into n individually controllable regions in the direction in which said liquid crystal display is vertically scanned,
the amounts of data conversion and light emission in said control unit and said gradation-setting voltage are determined repeatedly n times within each frame period, and applied to each region of said illuminator and to each region of said liquid crystal display opposite to said illuminator, and
said gradation-setting voltage generated from said gradation-setting voltage generator is changed n times within each frame period.

15. A liquid crystal display apparatus according to claim 9, wherein when the determination of amounts of data conversion and light emission is repeated n times within each frame period, the amount of light emission based on the data analysis of the (m+1)-th region is reflected on the conversion to said display-data for the m-th region of n regions.

16. A liquid crystal display apparatus according to claim 13, wherein the capacity of said image memory is 1/n the amount of one-frame data.

17. A liquid crystal display apparatus according to claim 13, wherein the capacity of said image memory is 2/n of the amount of one-frame data.

18. A liquid crystal display apparatus according to claim 13, wherein said n is an integer between 8 and 16 both inclusive.
